(19) United States
(12) Patent Application Publication
(10) Pub. No.: US 2009/0150082 A1
(43) Pub. Date: Jun. 11, 2009

(54) Method and system for realizing collaboration between bio-signal measurement devices

(75) Inventors: Kyu Chang Kang, Daejeon (KR); Ki Ryong Ha, Daejeon (KR); Young Sung Kim, Daejeon (KR); Dong-Oh Kang, Daejeon (KR); Jeun Woo Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/155,551

(22) Filed: Jun. 5, 2008

(30) Foreign Application Priority Data
Dec. 11, 2007 (KR) 10-2007-0128035

(51) Int. Cl. G06F 19/00

(52) U.S. Cl. 702/19

(57) ABSTRACT

The present invention relates to technology for realizing collaboration between bio-signal measurement devices used for personal health care. In a method of realizing collaboration between bio-signal measurement devices, connection to a plurality of bio-signal measurement devices for measuring bio-signals from a user is made, and a plurality of pieces of bio-signal data is received from the bio-signal measurement devices. First features are calculated from respective pieces of bio-signal data. Data required for calculation of second features is selectively received from the calculated first features, second features are calculated. The calculated first and second features are normalized, and the normalized first and second features are transmitted to at least one application program.

### CROSS-REFERENCE(S) TO RELATED APPLICATIONS

The present invention claims priority of Korean Patent Application No. 10-2007-0128035, filed on Dec. 11, 2007, which is incorporated herein by reference.

### FIELD OF THE INVENTION

The present invention relates, in general, to bio-signal measurement devices used for personal health care, and, more particularly, to a method and system for realizing collaboration between bio-signal measurement devices, which are suitably used to obtain health-related index values by extracting precise features from bio-signal data through collaboration between user-wearable bio-signal measurement devices, such as a wristlet, a chest strap, and a necklace, and home health care devices.

This work was supported by the IT R&D program of MIC/IITA. [2005-S-069-03, Wearable System Using Physiological Signal Processing]

### BACKGROUND OF THE INVENTION

Recently, with the aging of society, the population has become aware of the importance of health care, health maintenance, and health promotion, regardless of age group. Many people not only get examinations or medical advice from specialists in medical facilities, such as hospitals, for the purpose of early detection or prevention of diseases, but also try to manage, maintain and promote their health using non-medical facilities, such as sports centers. As interest in health greatly increases, the necessity for home-based health care service, which does not require visits to specialized facilities, such as hospitals, has increased, and thus research into the development of bio-signal measurement devices having no temporal or spatial restrictions has been widely conducted.

A home-based health care service is provided by home health care devices for monitoring users' health or continuing to provide medical care in the home, and an example thereof is a service for installing a bio-signal measurement device in the home of a patient and transmitting measured bio-information to the host computer of a specialized medical facility through a public telecommunication line. Since such home health care devices can perform measurement in the home, there is an advantage in that bio-information can be more frequently acquired, and thus the latest information can be obtained, but the use of such devices may be limited to the home.

Accordingly, research into technology for measuring the bio-signals of a user without temporal or spatial restrictions and for performing health care on the basis of the measured bio-signals has been continuously conducted. For example, a pulse rate sensing function has been implemented in a mobile phone, so that a user can hold the mobile phone to his or her body, and the pulse rate information of the user measured by the mobile phone is transmitted to the host computer of a specialized medical facility.

Meanwhile, bio-signals measured using a user's portable bio-signal measurement devices and home health care devices may include information about height, weight, etc., as well as blood pressure, pulse rate, percent body fat, and analytical data for sweat or urine. Technology for detecting abnormalities or preventing diseases in the user's health through medical examinations using such devices has been developed.

In the case of the conventional bio-signal measurement devices for personal health care, operated as described above, bio-features are acquired from bio-signal data for individual devices, and are used for health care programs. However, bio-features acquired from individual devices are merely used in different fields of health care programs, and there is no particular method of generating higher-quality bio-features through collaboration between bio-signal measurement devices, composite measurement, etc.

### SUMMARY OF THE INVENTION

It is, therefore, an object of the present invention to provide a method and system for realizing collaboration between bio-signal measurement devices, which can acquire high-quality bio-signal data values through collaboration between the bio-signal measurement devices.

Another object of the present invention is to provide a method and system for realizing collaboration between bio-signal measurement devices, which can acquire the features of high-quality bio-signal data by realizing collaboration between different bio-signal measurement devices at the driver level.

A further object of the present invention is to provide a method and system for realizing collaboration between bio-signal measurement devices, which can extract more precise features from bio-signal data by realizing collaboration between user-wearable bio-signal measurement devices, such as a wristlet, a chest strap, and a necklace, and home health care devices to obtain health-related index values.

Yet another object of the present invention is to provide a method and system for realizing collaboration between bio-signal measurement devices, which can acquire different types of bio-signal data from various bio-signal measurement devices and extract fundamental bio-features that can be provided by respective devices from the acquired bio-signal data, and which can additionally receive bio-signal data sensed by other devices and extract second features from the received bio-signal data.

In accordance with a preferred embodiment of the present invention, there is provided a method of realizing collaboration between bio-signal measurement devices, including: making connection to a plurality of bio-signal measurement devices for measuring bio-signals from a user and receiving a plurality of pieces of bio-signal data from the bio-signal measurement devices; calculating first features from respective pieces of bio-signal data; calculating second features by selectively receiving data, required for calculation of second features, from among the calculated first features; and normalizing the calculated first and second features, and transmitting normalized first and second features to at least one application program.

In accordance with another preferred embodiment of the present invention, there is provided a system for realizing collaboration between bio-signal measurement devices, including: a plurality of bio-signal measurement devices for measuring bio-signals from a user; a portable information terminal for installing each of feature extraction drivers corresponding to each of the bio-signal measurement devices found in a search for the bio-signal measurement devices, receiving bio-signal data measured by the bio-signal measurement devices, calculating first features from the received bio-signal data, calculating the second features by selectively receiving data, required for calculation of second features, from among the first features calculated from a plurality of pieces of bio-signal data; a service provider server for receiving both bio-signal data measured from the user and the features, managing a condition of health of the user, and providing health-related application programs to the portable information terminal; and a measurement device provider server, operating in cooperation with the portable information terminal, for providing device information of each of the bio-signal measurement devices and each of feature extraction drivers corresponding to each of the bio-signal measurement devices in response to a request from the portable information terminal.

In accordance with a further preferred embodiment of the present invention, there is provided a system for realizing collaboration between bio-signal measurement devices, including: at least one communication driver connected to a plurality of bio-signal measurement devices for measuring bio-signals from a user, and configured to receive a plurality of pieces of bio-signal data and to transmit the received bio-signal data to a plurality of first feature extraction drivers; the first feature extraction drivers for receiving the bio-signal data from the communication driver and calculating first features; a plurality of second feature extraction drivers for extracting second features by selectively receiving data, required for calculation of the second features, from respective first feature extraction drivers; a feature normalization unit for receiving the features extracted by the first and second feature extraction drivers, normalizing the features, and transmitting normalized features to at least one application program; and a device management unit for finding each of the bio-signal measurement devices by searching for the bio-signal measurement device, and installing and managing first and second feature extraction drivers corresponding to the found bio-signal measurement device.

In the present invention, advantages obtained by representative embodiments of the disclosed invention are briefly described below.

The present invention is advantageous in that, in a ubiquitous health care environment, the features of high-quality bio-signal data can be acquired through the combination of bio-signal measurement devices worn by users and devices that can be used at home, and the function of automatically searching for bio-signal measurement devices and the function of realizing collaboration between found devices are provided, thus enabling personal health care to be precisely conducted in an environment in which various bio-signal measurement devices are used.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing the construction of a system for realizing collaboration between bio-signal measurement devices according to a preferred embodiment of the present invention;

FIG. 2 is a block diagram showing the construction of a communication driver unit in a portable information terminal according to a preferred embodiment of the present invention;

FIG. 3 is a block diagram showing the construction of a low-level feature extraction driver according to a preferred embodiment of the present invention;

FIG. 4 is a block diagram showing the construction of a high-level feature extraction driver according to a preferred embodiment of the present invention;

FIG. 5 is a block diagram showing the construction of a feature normalization unit according to a preferred embodiment of the present invention;

FIG. 6 is a block diagram showing the construction of a device management unit according to a preferred embodiment of the present invention; and

FIG. 7 is a flow chart showing a process for finding a bio-signal measurement device and installing a driver according to a preferred embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art. Further, detailed descriptions may be omitted if it is determined that the detailed descriptions of related well-known functions and constructions may make the gist of the present invention unclear. Further, the following terms are defined in consideration of the functionality in the present invention, and may vary according to the intention of a user or an operator, usage, etc. Therefore, the definition should be made on the basis of the overall content of the present specification.

The present invention provides a scheme for acquiring bio-features from bio-signal data measured by respective bio-signal measurement devices and utilizing the acquired bio-features for health care programs, and is implemented to generate high-quality bio-features through collaboration between accessory-type small-sized devices worn on the body of a user and home health care devices in a ubiquitous health care environment.

That is, the present invention is implemented to acquire different types of bio-signal data from various bio-signal measurement devices and extract fundamental bio-features that can be provided by respective devices from the acquired bio-signal data, and to additionally receive bio-signal data sensed by other devices and extract second features from the received bio-signal data.

Further, in order to perform the connection between respective bio-signal measurement devices and a portable information terminal, the present invention enables respective bio-signal measurement devices to be automatically found and low-level feature extraction drivers to be automatically installed through the device management unit, and provides high-level feature extraction drivers for receiving bio-signal data from the low-level feature extraction drivers of respective bio-signal measurement devices and extracting second features, thus providing optimal bio-features regardless of any combinations of bio-signal measurement devices worn by a user in a ubiquitous health care environment.

### Embodiment

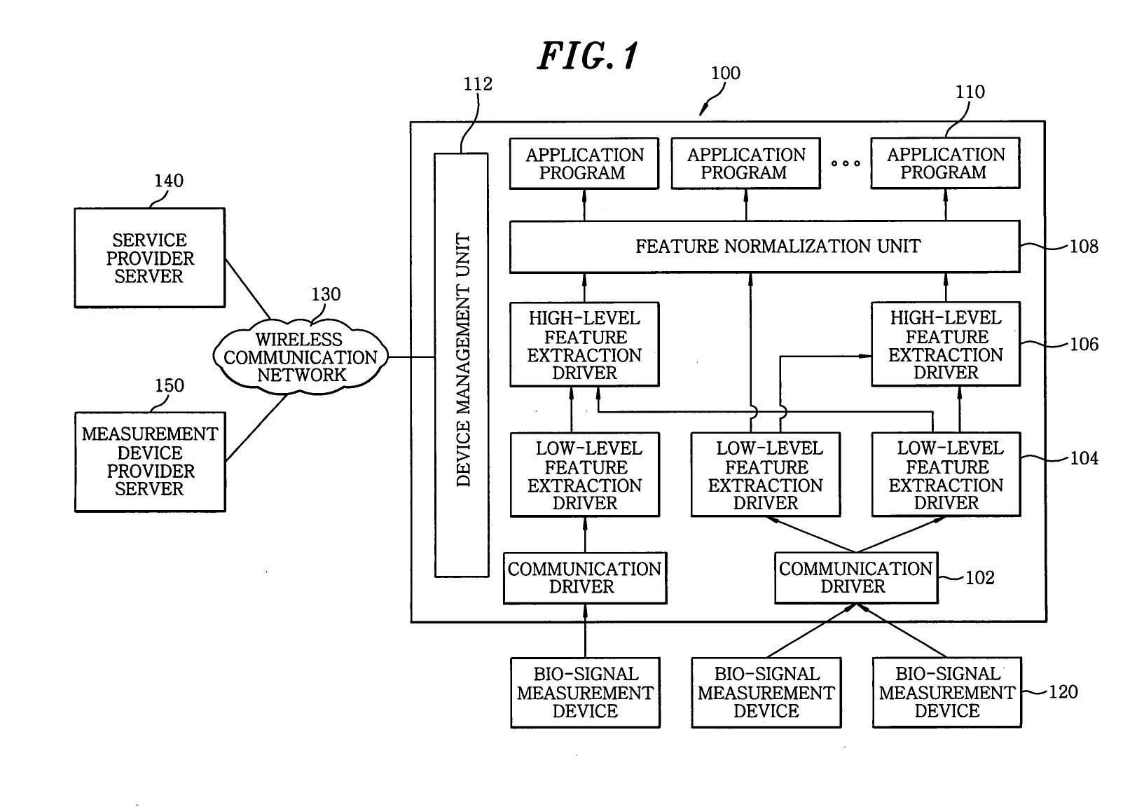

FIG. 1 is a block diagram showing the construction of a system for realizing collaboration between bio-signal measurement devices according to a preferred embodiment of the present invention.

Referring to FIG. 1, the system for realizing collaboration between bio-signal measurement devices includes a portable information terminal 100, bio-signal measurement devices 120, a service provider server 140, and a measurement device provider server 150.

The bio-signal measurement device 120 may include user-wearable devices, such as a wristlet, a chest strap, and a necklace, and home health care devices, and are configured to sense bio-signals from a user and transmit the sensed bio-signals to the portable information terminal 100 through wireless communication, such as ZigBee or Bluetooth. In this case, the bio-signals that can be measured include heart rate, body temperature, blood pressure, etc. When an acceleration sensor and an angular velocity sensor are attached to each device, acceleration data and angular velocity data based on the motion of the user are included in bio-signals, which are transmitted to the portable information terminal 100.

Further, when each of the bio-signal measurement devices 120 is powered on, it transmits a radio signal using ZigBee or Bluetooth to the portable information terminal 100, thus enabling the portable information terminal 100 to find the bio-signal measurement device 120 through the search for the radio signal. The found bio-signal measurement device 120 transmits location information (Universal Resource Identifier: URI), including device information, to the portable information terminal 100 to allow the portable information terminal 100 to register the device. When subsequently measuring the bio-signal of the user, the bio-signal measurement device 120 periodically transmits the measured bio-signal to the portable information terminal 100.

The portable information terminal 100 is a portable device having information processing ability, such as a smart phone, a Personal Digital Assistant (PDA), a Portable Multimedia Player (PMP), or an Ultra Mobile PC (UMPC), and includes communication drivers 102 for receiving a plurality of pieces of bio-signal data from the plurality of bio-signal measurement devices 120, low-level feature extraction drivers 104 for respective bio-signal measurement devices 120, and high-level feature extraction drivers 106 for selectively receiving data from low-level feature extraction drivers 104 for different devices and calculating high-level features.

Further, the portable information terminal 100 includes a feature normalization unit 108, which standardizes the features extracted by the feature extraction drivers 104 and 106, for standardizing or normalizing the extracted features according to a preset format and transmitting the resulting features to application programs, thus enabling the application programs to use the resulting features in a predetermined pattern, a device management unit 112 for performing the plug & play function of the bio-signal measurement devices, such as the automatic recognition of devices and the installation and management of the feature extraction drivers, and application programs 110 for performing analysis and statistics using normalized features.

The portable information terminal 100 having the above construction is connected to a wireless communication network 130 through a mobile communication network or a Wireless Broadband (Wibro) network, and is connected to both the service provider server 140 and the measurement device provider server 150 through the wireless communication network 130.

The service provider server 140 is a server for providing health-related application programs, such as health portals, and functions to transmit a selected application program to the portable information terminal 100 when the user subscribes to a service, and to receive features or bio-signal data measured from the user, thus managing the condition of the user's health.

The measurement device provider server 150 is the server of a company producing the bio-signal measurement devices 120, and functions to store the device information of the bio-signal measurement devices 120, the feature extraction drivers of respective devices, etc., and to operate in cooperation with the portable information terminal 100 in order to allow the portable information terminal 100 to perform a plug & play function when the bio-signal measurement devices 120 are connected to the portable information terminal 100.

FIG. 2 is a block diagram showing the construction of a communication driver in the portable information terminal according to a preferred embodiment of the present invention.

Referring to FIG. 2, the communication driver 102 functions to perform communication with the bio-signal measurement devices 120 that use the same communication protocol, and to transmit a plurality of pieces of bio-signal data, received from the bio-signal measurement devices 120, to the low-level feature extraction drivers 104. The bio-signal reception unit 206 of the communication driver 102 receives bio-signal data from the bio-signal measurement devices 120 using a communication protocol such as ZigBee or Bluetooth.

The bio-signal data received by the bio-signal reception unit 206 is transferred to a transmission unit 204, and is then transmitted to the low-level feature extraction drivers 104 through the transmission unit 204. When a specific bio-signal measurement device 120 performs a plug & play function, the control unit 200 of the communication driver 102 receives port numbers for respective low-level feature extraction drivers from the device management unit 112 and stores the port numbers in a port table storage unit 202. Input bio-signal data is mapped to corresponding port number stored in the port table storage unit 202, and the bio-signal data mapped to the corresponding port number is transmitted to the low-level feature extraction driver 104 corresponding to the port number through the transmission unit 204.

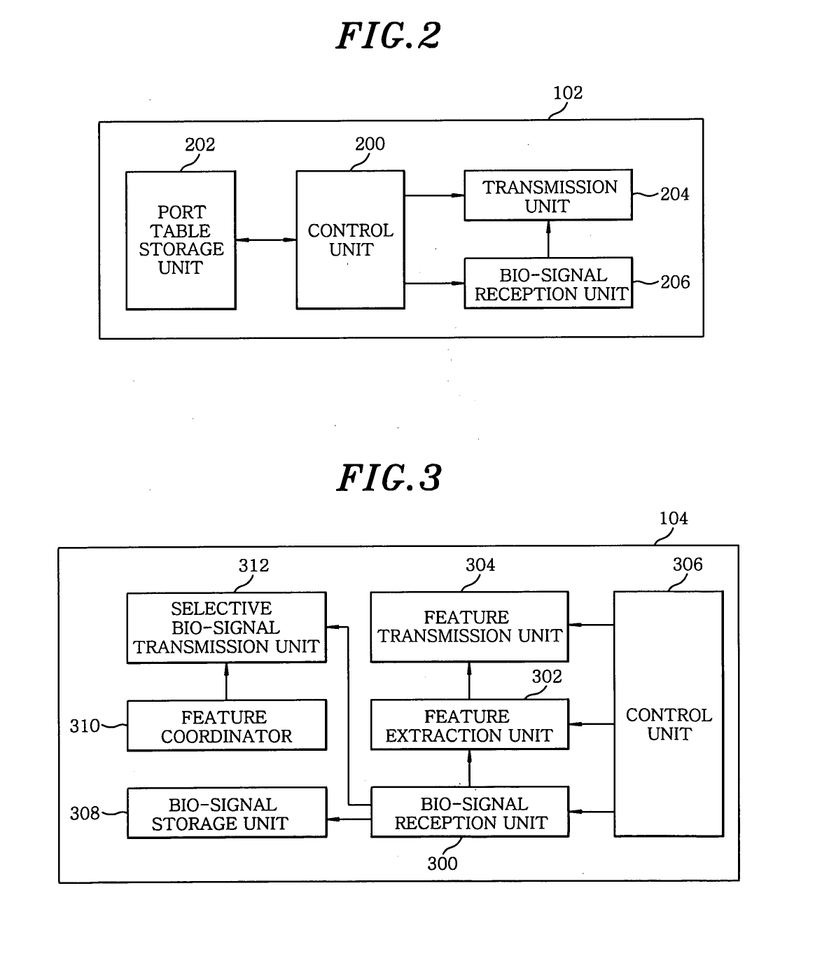

FIG. 3 is a block diagram showing the construction of a low-level feature extraction driver according to a preferred embodiment of the present invention.

Referring to FIG. 3, a low-level feature extraction driver 104 exists for each of the bio-signal measurement devices 120, and is a module for calculating bio-features such as heart rate, body temperature, and blood pressure from bio-signal data.

The control unit 306 of the low-level feature extraction driver 104 controls all functional blocks provided in the low-level feature extraction driver 104, and each functional block is driven under the control of the control unit 306. A bio-signal reception unit 300 receives bio-signal data measured by the bio-signal measurement devices 120 through the communication driver 102, and transmits the received source bio-signal data to a bio-signal storage unit 308 to store the bio-signal data in the bio-signal storage unit 308.

A feature extraction unit 302 calculates features from the bio-signal data received from the bio-signal reception unit 300, and transmits the calculated features to the feature normalization unit 108 through a feature transmission unit 304. Further, a feature coordinator 310 adjusts collaboration with the high-level feature extraction drivers 106. A selective bio-signal transmission unit 312 selectively transmits bio-signal data, which is required for the extraction of high-level features, to the high-level feature extraction drivers 106.

For example, when the body temperature and angular velocity data of the user are measured using a necklace, the measured signals are bio-signal data and are received by the bio-signal reception unit 300 of the low-level feature extraction driver 104. The received bio-signal data is transmitted to the feature extraction unit 302, so that the feature extraction unit 302 calculates the body temperature and angular velocity of the user. Thereafter, the feature coordinator 310 recognizes, through collaboration with a specific high-level feature extraction driver 106, that the high-level feature extraction driver 106 requires angular velocity data so as to calculate high-level features. The selective bio-signal transmission unit 312 selects the angular velocity data, which is required for the extraction of high-level features, from among the body temperature data and the angular velocity data, and transmits the selected angular velocity data to the high-level feature extraction driver 106.

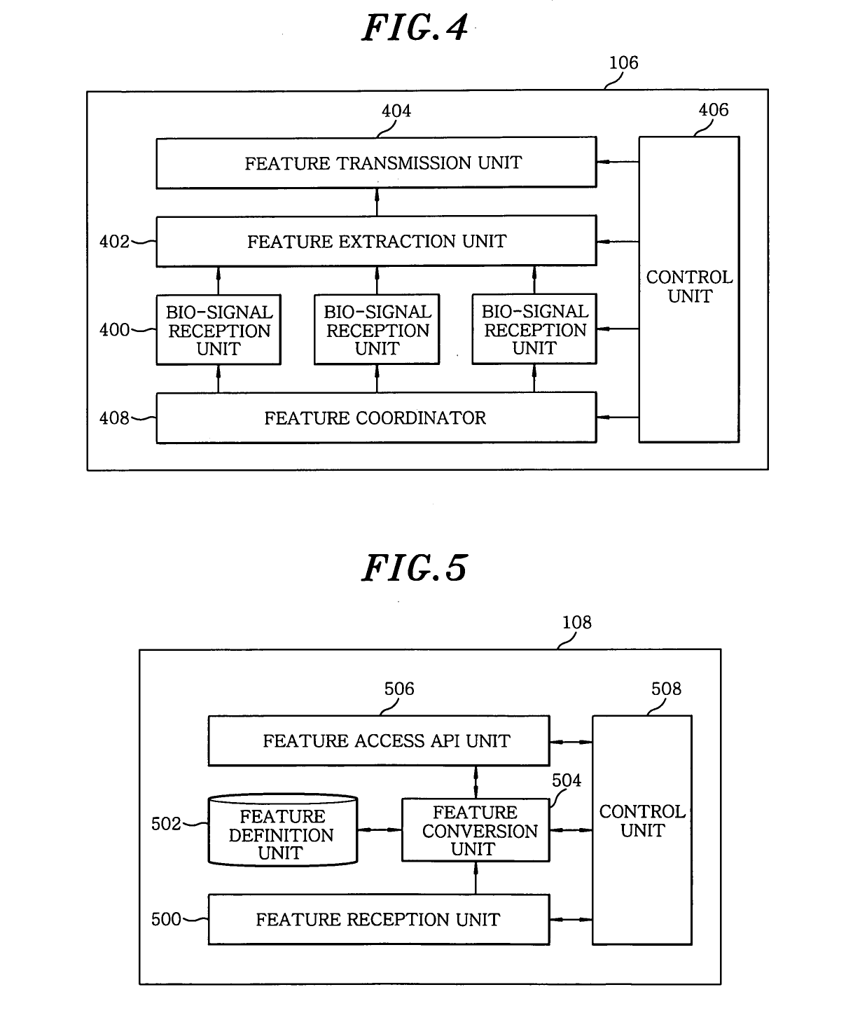

FIG. 4 is a block diagram showing the construction of a high-level feature extraction driver according to a preferred embodiment of the present invention.

Referring to FIG. 4, a high-level feature extraction driver 106 is a module for selectively receiving bio-signal data from a plurality of low-level feature extraction drivers 104 and calculating high-level features. For example, when a feature, such as momentum, is calculated, as many pieces of angular velocity data and acceleration data as possible are required in order to improve the precision of calculation. That is, precise calculation is performed by using all of the acceleration and angular velocity data measured by acceleration sensors and angular velocity sensors attached to a wristlet, a chest strap, a necklaces, etc.

The bio-signal reception units 400 of the high-level feature extraction driver 106 selectively receive bio-signal data, which is required for the calculation of high-level features, from the plurality of low-level feature extraction drivers 104. A feature extraction unit 402 calculates and extracts features from the received bio-signal data. The features extracted by the feature extraction unit 402 are transmitted to a feature transmission unit 404, so that the feature transmission unit 404 transmits the features to the feature normalization unit 108.

Further, a feature coordinator 408 adjusts collaboration with the low-level feature extraction drivers 104, and transmits adjusted collaboration information to the bio-signal reception units 400. That is, adjustment is performed such that, among the bio-signal data received by the low-level feature extraction drivers 104, data required to calculate high-level features is selected, and the bio-signal reception units 400 receive the selected data from the low-level feature extraction drivers 104.

In this case, the control unit 406 of the high-level feature extraction driver 106 controls all of the functional blocks provided in the high-level feature extraction driver 106, and respective functional blocks are driven under the control of the control unit 406.

FIG. 5 is a diagram showing the construction of a feature normalization unit according to a preferred embodiment of the present invention.

Referring to FIG. 5, the feature normalization unit 108 functions to define the format of features extracted from bio-signals and to standardize or normalize the extracted features in a predetermined format, thus allowing the application programs 110, which perform health care, analysis and statistics using the extracted features, to use the standardized or normalized features in a predetermined manner.

Further, in the feature normalization unit 108, a feature reception unit 500 receives features from the low-level and high-level feature drivers 104 and 106, and a feature definition unit 502 defines and stores the format of features. Further, a feature conversion unit 504 converts features according to the format defined by the feature definition unit 502. A feature access Application Programming Interface (API) 506 enables the application programs to use features in a predetermined pattern. Respective functional blocks are driven under the control of a control unit 508.

Meanwhile, the standardization and normalization of features are defined using Extensible Markup Language (hereinafter referred to as an “XML”).

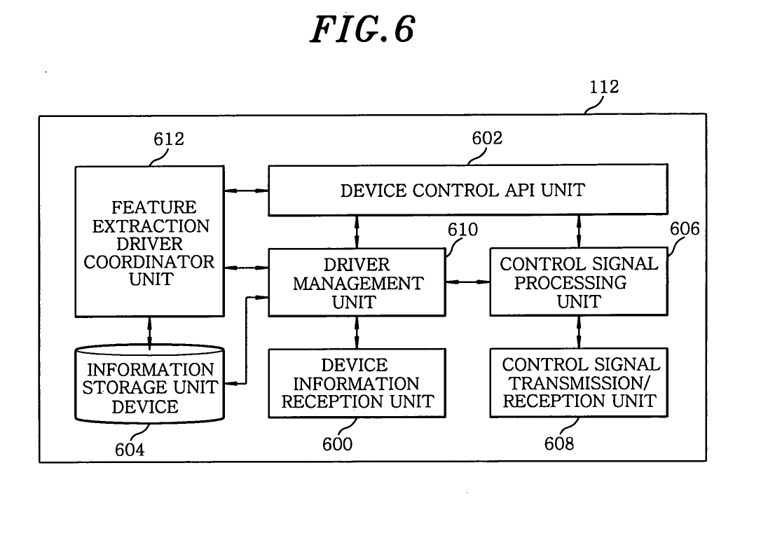

FIG. 6 is a block diagram showing the construction of a device management unit according to a preferred embodiment of the present invention.

Referring to FIG. 6, the device management unit 112 performs the functions, such as a plug & play function for finding a bio-signal measurement device 120 by searching for the bio-signal measurement device 120 and automatically installing the feature extraction drivers 104 and 106 corresponding to the bio-signal measurement device 120, the management of the combination of feature extraction drivers, which are required for the calculation of high-level features and are arbitrarily detachable from the measurement devices, and the management of lifecycles of the feature extraction drivers.

The device information reception unit 600 of the device management unit 112 receives location information (URI), including device information, from the bio-signal measurement devices 120, and stores the location information in a device information storage unit 604. A device control API unit 602 downloads device information from the received location information, parses a device descriptor included in the device information, and compares the parsed device descriptor with device information previously stored in the device information storage unit 604.

Thereafter, when the parsed device descriptor is not identical to any of the previously stored device information, the relevant device for the parsed device descriptor is a new bio-signal measurement device. Accordingly, the device management unit 112 accesses the measurement device provider server 150 through a driver management unit 610 for managing feature extraction drivers for respective devices, thus requesting a feature extraction driver for the relevant device from the measurement device provider server 150. When the requested feature extraction driver is received from the measurement device provider server 150, the feature extraction driver is installed in the portable information terminal 100.

The control signal transmission/reception unit 608 of the device management unit 112 transmits or receives control signals which are used to control the bio-signal measurement devices 120. A control signal processing unit 606 processes the control signals transmitted or received through the control signal transmission/reception unit 608. The device control API unit 602 controls the functional blocks of the device management unit 112, and provides a developer API for permitting access to the bio-signal measurement devices 120.

A feature extraction driver coordinator unit 612, which is configured to adjust collaboration between the feature extraction drivers 104 and 106 to extract high-level features, adjusts collaboration between the low-level and high-level feature extraction drivers 104 and 106 by using the registration and management of feature types of all detachable devices and notification using events. The adjusted collaboration information is transmitted to the driver management unit 610 and the device control API unit 602, so that the bio-signal measurement devices 120 are controlled on the basis of the adjusted collaboration information when the devices are controlled.

That is, collaboration between the low-level feature coordinator 310 and the high-level feature coordinator 408 is adjusted, so that, among the calculated low-level features, low-level features required for the calculation of high-level features are selected, and thus the high-level feature extraction drivers 106 can receive the selected low-level features.

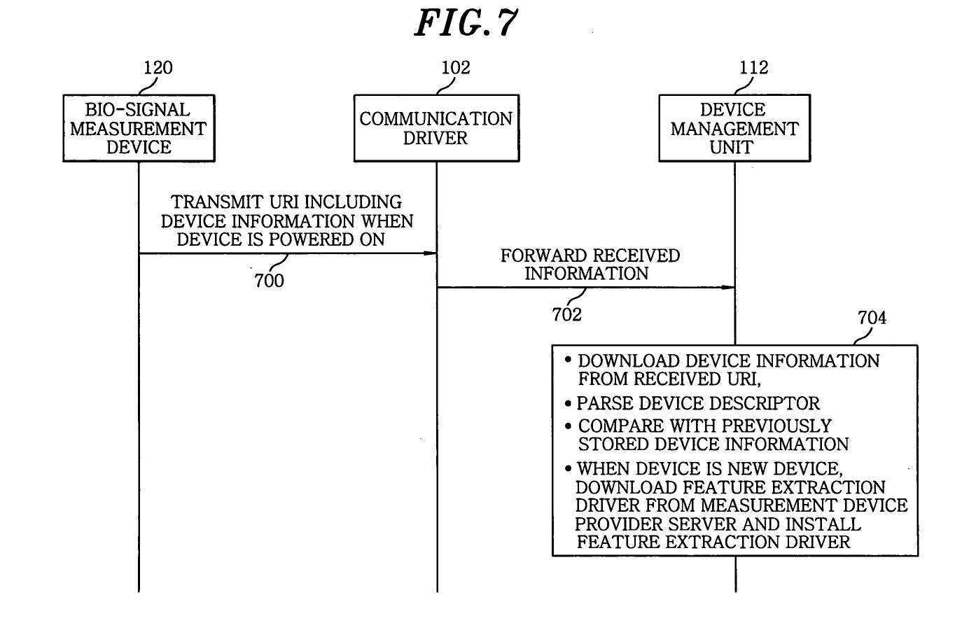

FIG. 7 is a flow chart showing a process for finding a bio-signal measurement device and installing a driver according to a preferred embodiment of the present invention.

Referring to FIG. 7, when a bio-signal measurement device 120 is powered on at step 700, the bio-signal measurement device 120 transmits the location information URI, including its own device information, to the communication driver 102 of the portable information terminal 100. The communication driver 102 forwards the URI of the bio-signal measurement device 120 to the device management unit 112 at step 702.

Thereafter, at step 704, the device management unit 112 downloads and parses the device information (typically stored in XML format) included in the received URI, thus analyzing the device information. Further, the device management unit 112 determines whether the analyzed device information is that of a new device by comparing the device information with previously stored device information. If it is determined that the device information is that of a new device, the feature extraction driver of the analyzed device is downloaded from the measurement device provider server 150, and is then installed.

As described above, the present invention relates to a scheme for acquiring bio-features from bio-signal data for respective devices and utilizing the acquired bio-features for health care programs, and is implemented to generate high-quality bio-features through collaboration between accessory-type small-sized devices worn on the body of the user and home health care devices in a ubiquitous health care environment.

While the invention has been shown and described with respect to the preferred embodiments, it will be understood by those skilled in the art that various changes and modifications may be made without departing from the spirit and scope of the invention as defined in the following claims. Therefore, the scope of the present invention is not limited to the above-described embodiments, and should be defined by equivalents to the scope of the accompanying claims as well as the claims.

What is claimed is:

1. A method of realizing collaboration between bio-signal measurement devices, comprising:
making connection to a plurality of bio-signal measurement devices for measuring bio-signals from a user and receiving a plurality of pieces of bio-signal data from the bio-signal measurement devices;
calculating first features from respective pieces of bio-signal data;
calculating second features by selectively receiving data, required for calculation of second features, from among the calculated first features; and
normalizing the calculated first and second features, and transmitting normalized first and second features to at least one application program.

2. The method of claim 1, further comprising:
searching for each of the bio-signal measurement devices;
receiving location information, including device information, from a found bio-signal measurement device; and
identifying the device information from the location information, and installing first and second feature extraction drivers corresponding to the device information.

3. The method of claim 1, wherein the first features include one of heart rate, body temperature, blood pressure, acceleration data, and angular velocity data.

4. The method of claim 1, wherein the second features include momentum data calculated using the first features.

5. A system for realizing collaboration between bio-signal measurement devices, comprising:
a plurality of bio-signal measurement devices for measuring bio-signals from a user;
a portable information terminal for installing each of feature extraction drivers corresponding to each of the bio-signal measurement devices found in a search for the bio-signal measurement devices, receiving bio-signal data measured by the bio-signal measurement devices, calculating first features from the received bio-signal data, calculating the second features by selectively receiving data, required for calculation of second features, from among the first features calculated from a plurality of pieces of bio-signal data, and;
a service provider server for receiving both bio-signal data measured from the user and the features, managing a condition of health of the user, and providing health-related application programs to the portable information terminal; and
a measurement device provider server, operating in cooperation with the portable information terminal, for providing device information of each of the bio-signal measurement devices and each of feature extraction drivers corresponding to each of the bio-signal measurement devices in response to a request from the portable information terminal.

6. The system of claim 5, wherein the bio-signal measurement devices are connected to the portable information terminal through ZigBee or Bluetooth and are configured to periodically transmit the measured bio-signals of the user to the portable information terminal.

7. The system of claim 5, wherein the portable information terminal is operated in cooperation with the service provider server and the measurement device provider server through a wireless communication network.

8. A system for realizing collaboration between bio-signal measurement devices, comprising:
at least one communication driver connected to a plurality of bio-signal measurement devices for measuring bio-signals from a user, and configured to receive a plurality of pieces of bio-signal data and to transmit the received bio-signal data to a plurality of first feature extraction drivers;
the first feature extraction drivers for receiving the bio-signal data from the communication driver and calculating first features;
a plurality of second feature extraction drivers for extracting second features by selectively receiving data, required for calculation of the second features, from respective first feature extraction drivers;
a feature normalization unit for receiving the features extracted by the first and second feature extraction drivers, normalizing the features, and transmitting normalized features to at least one application program; and
a device management unit for finding each of the bio-signal measurement devices by searching for the bio-signal measurement device, and installing and managing first and second feature extraction drivers corresponding to the found bio-signal measurement device.

9. The system of claim 8, wherein the at least one communication driver maps port numbers of respective first feature extraction drivers to the bio-signal data received from the plurality of bio-signal measurement devices, and transmits the bio-signal data to the first feature extraction drivers corresponding to respective port numbers.

10. The system of claim 8, wherein each of the first feature extraction drivers comprises a first feature coordinator for allowing first features, required for calculation of the second features, to be selected from among the calculated first features by collaborating with the second feature extraction drivers.

11. The system of claim 8, wherein each of the second feature extraction drivers comprises a second feature coordinator for allowing first features, required for calculation of the second features, to be selected from among the calculated first features by collaborating with the first feature extraction driver.

12. The system of claim 8, wherein the device management unit:
searches for each of the bio-signal measurement devices;
receives location information (Uniform Resource Identifier: URI), including device information, from the found device;
downloads the device information from the received location information;
analyzes the device information;
requests a feature extraction driver corresponding to a bio-signal measurement device, the device information of which is analyzed, to a measurement device provider server for storing the feature extraction driver,
receives the feature extraction driver, and;
installs the received feature extraction driver.

13. The system of claim 12, wherein the device management unit comprises a feature extraction driver coordinator for performing registration and management of feature types of all detachable devices, and controlling collaboration performed between the first and second feature extraction drivers, thus adjusting selection of first features required for calculation of the second features.

14. The system of claim 8, wherein the first features include one of heart rate, body temperature, blood pressure, acceleration data, and angular velocity data.

15. The system of claim 8, wherein the second features include momentum data calculated using the first features.
